(19) United States
(12) Patent Application Publication
(10) Pub. No.: US 2021/0205834 A1
(43) Pub. Date: Jul. 8, 2021

(54) WATER FEATURE

(71) Applicant: Beckett Corporation, Irving, TX (US)

(72) Inventors: Hsueh Hsiung Hsieh, Carrollton, TX (US); Jose Leon, Carrollton, TX (US); Lydia Lesinski, Euless, TX (US); Wingate Sung, Dallas, TX (US)

(21) Appl. No.: 17/123,503

(22) Filed: Dec. 16, 2020

Related U.S. Application Data
(60) Provisional application No. 62/949,287, filed on Dec. 17, 2019.

(51) Int. Cl. B05B 17/08; B05B 17/06

(52) U.S. Cl. CPC B05B 17/08; H02S 99/00; B05B 17/06

(57) ABSTRACT

A water apparatus comprising a shell surrounding a reservoir that rotates about a pivot point between at least a first position and a second position. When the shell is in the first position, the reservoir and the top portion of the shell are at a first balance point, which comprises the shell being in an open position and the reservoir being able to retain water. When the shell is in the second position, the reservoir and the top portion of the shell are at a second balance point, which comprises the shell being in a closed position and the rigid tube being able to release water.

### CROSS-REFERENCE TO RELATED APPLICATIONS

This application claims the benefit of U.S. Provisional Patent Application No. 62/949,287, filed Dec. 17, 2019, the disclosure of which is hereby incorporated by reference as if fully set forth in its entirety herein.

### BACKGROUND

Water features are used in landscaping and pondscaping applications for both functional and aesthetic purposes. However, there is a demand for automated of water features and for water features having animatronic features. Therefore, it is desired to provide an automated water feature having animatronic features.

### SUMMARY

The present disclosure includes disclosure of a water device. In at least one embodiment, a water device according to the present disclosure comprises a base; a frame, the frame having a first end coupled to the base and an opposing second end, the frame extending away from the base; a reservoir affixed to the second end of the base, the reservoir having a closed end and an opposing open end, the reservoir configured to pivot about a point of affixation to the second end of the frame; a pump; a tube fluidly coupling the pump to the closed end of the reservoir; and a shell surrounding the base, the frame, and the reservoir, the shell comprising an upper component and a lower component, the upper component affixed to the reservoir and the lower component affixed to the base.

In an aspect of at least one embodiment of a water device according to the present disclosure, the reservoir comprises a rigid tube capable of retaining a liquid.

In an aspect of at least one embodiment of a water device according to the present disclosure, the water device further comprising one or more solar panels.

In an aspect of at least one embodiment of a water device according to the present disclosure, the water device further comprising a plurality of illuminators.

In an aspect of at least one embodiment of a water device according to the present disclosure, the water device further comprising an ultrasonic fogger, an ultrasonic mister, an air pump, and a sound module.

In an aspect of at least one embodiment of a water device according to the present disclosure, the resin shell comprises a character head.

In an aspect of at least one embodiment of a water device according to the present disclosure, the character head comprises an animal head.

In an aspect of at least one embodiment of a water device according to the present disclosure, the pump is rigidly mounted to the base.

In an aspect of at least one embodiment of a water device according to the present disclosure, the pump is unmounted from the base.

In an aspect of at least one embodiment of a water device according to the present disclosure, the pump is operable to fill the reservoir with a liquid via the tube.

In an aspect of at least one embodiment of a water device according to the present disclosure, when the reservoir is at least partially filled, the reservoir pivots about the point of affixation to the second end of the frame, causing the liquid to be released through the open end of the reservoir.

In an aspect of at least one embodiment of a water device according to the present disclosure, when the liquid is released through the open end of the reservoir, the reservoir pivots about the point of affixation, returning to a position wherein the fluid can be retained in the reservoir.

The present disclosure includes disclosure of a water apparatus. In at least one embodiment, a water apparatus according to the present disclosure comprises a rigid tube; a pivot point, the rigid tube rotatable about the pivot point; and a resin shell, the resin shell comprises a first position and a second position; wherein the pivot point allows the rigid tube and a top portion of the resin shell to rotate between the first position and the second position; wherein when the resin shell is in the first position when the rigid tube and the top portion of the resin shell are at a first balance point, which comprises the resin shell being in an open position; and wherein when the resin shell is in the second position when the rigid tube and the top portion of the resin shell are at a second balance point, which comprises the resin shell being in a closed position.

In an aspect of at least one embodiment of a water apparatus according to the present disclosure, the rigid tube comprises a rigid PVC tube and is disposed within the top portion of the resin shell.

In an aspect of at least one embodiment of a water apparatus according to the present disclosure, the rigid tube comprises a closed rear end, an open front end, a rear portion and a front portion.

### BRIEF DESCRIPTION OF DRAWINGS

The features and advantages of this disclosure, and the manner of attaining them, will be more apparent and better understood by reference to the following descriptions of the disclosed methods and systems, taken in conjunction with the accompanying drawings, wherein:

FIG. 1 is cutaway side view of a water feature according to at least one embodiment of the present invention;

FIG. 2 is a side view of a water feature in an open position according to at least one embodiment of the present invention; and

FIG. 3 is a side view of a water feature in a closed position according to at least one embodiment of the present invention.

### DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

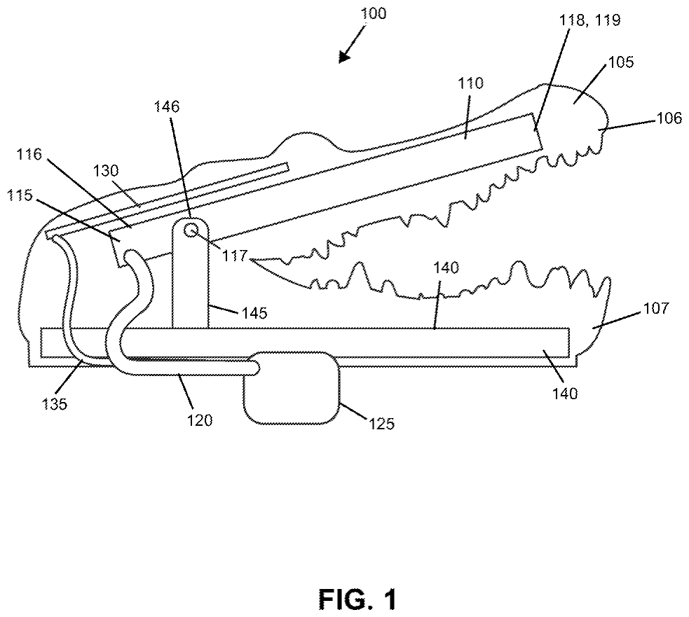

FIGS. 1-3 illustrate an animated and illuminated water feature 100 according to the present disclosure. In at least one embodiment, such a water feature 100 may comprise a reservoir 110, a water pump 125, a tube 120 fluidly coupling reservoir 110 and water pump 125, a base 140, a frame 145 connecting base 140 to reservoir 110 at pivot point 117, a plurality of LED lights 150, one or more solar power panel(s) 130, and a resin shell 105. The resin shell 105 may comprise a top portion 106 and a bottom portion 107. The resin shell 105 may be designed in the shape of a character head, such as, for example, an animal head or other shapes. Water feature 100 may also comprise an ultrasonic fogger/mister (not shown), an air pump (not shown), a sound module (not shown).

The reservoir 110 may be, for example, a rigid tube made of PVC material or other rigid materials known in the art. Water pump 125 may be a submersible water pump. The water pump 125, LED lights 150, and other electric components such as an optional ultrasonic fogger/mister, air pump, and sound module, may be powered by electricity from solar power panel 130 via wiring 135. Alternatively, a low voltage power source (not shown) such as, for example, a battery, a DC power source, or AC power source.

As illustrated in FIGS. 1-3, the water feature 100 may include a reservoir 110 disposed inside and affixed to a top portion 106 of the resin shell 105. The reservoir 110 comprises a vessel capable of retaining a fluid, and having a closed rear end 115 and an open front end 118. Reservoir 110 comprises a rear portion 116 and a front portion 119. In at least one embodiment, reservoir 110 comprises a hollow, tubular shape constructed of PVC material or other rigid materials. In another embodiment, reservoir 110 may be constructed of non-rigid material.

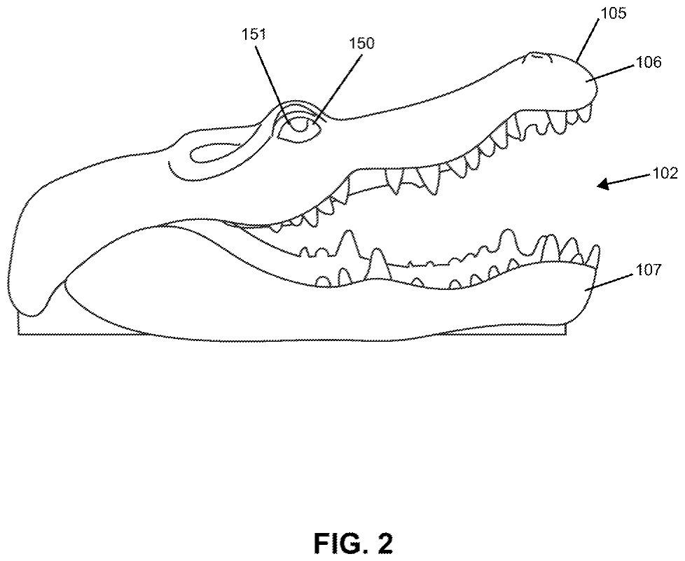

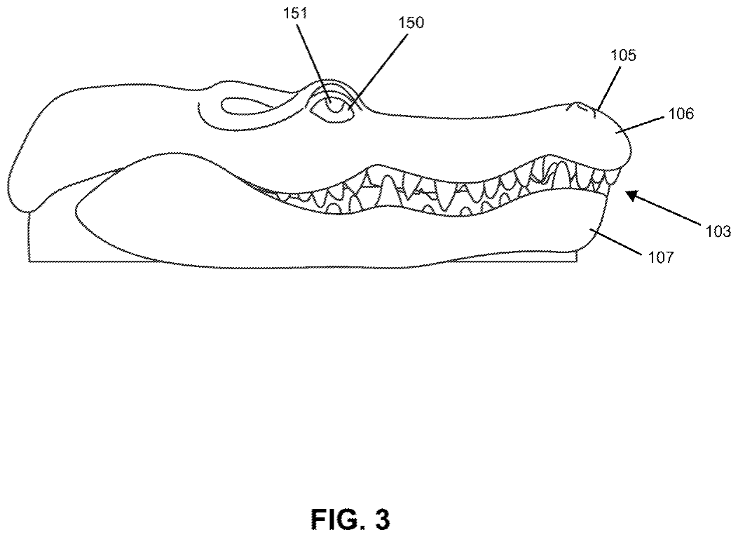

Reservoir 110 is rotatably coupled to a top portion 146 of the frame 145 at the pivot point 117. Pivot point 117 may be closer to than to front portion 119 in at least one embodiment. The pivot point 117 may allow the reservoir 110 and the top portion 106 of the resin shell 105 to rotate between a first position 102 and a second position 103, as illustrated in FIGS. 2 and 3. In at least one embodiment, pivot point 117 acts a fulcrum. Water feature 100 will be in first position 102 if the weight toward the rear portion 116 of reservoir 110, taking into account the weight of reservoir 110 on the rear portion 116 side of the fulcrum, its contents, and the other components of water feature 100 on that side of the fulcrum is greater than the weight toward the front portion 119 of reservoir 110, taking into account the weight of reservoir 110 on the front portion 119 side of the fulcrum, its contents, and the other components of water feature 100 on that side of the fulcrum. In the first position 102, reservoir 110 and the top portion 106 of the resin shell 105 may be at a first balance point, for example, an open position of the resin shell 105. Optionally, a counterweight (not shown) may be included adjacent rear portion 116 of reservoir 110.

Water feature 100 may be deployed in a body of water. When deployed in a body of water, water feature 100 will float atop the surface of the body of water, while water pump 125 is submerged below the surface of the body of water. Water feature 100 may be equipped with an anchor line (not shown) to retain water feature 100 in a stationary position. The anchor line may be, for example, a string, rope, or chain with one end connected to water feature 100 and the other end connected to a weight sitting on bottom of the body of water in which water feature 100 is deployed. Alternatively, anchor line may be, for example, pump 125 serving as an anchor with tube 120 acting as the anchor line between pump 125 and the rest of water feature 100.

While in the first position 102, the water pump 125 may pump water into rear portion 116 of the reservoir 110 through the tube 120, with the water being held within the reservoir 110 by the closed end 115 of the reservoir 110. Water feature 100 will rotate to the second position 103 when the weight of reservoir 110 on the front portion 119 side of the fulcrum, its contents, and the other components of water feature 100 on that side of the fulcrum overcomes the weight of reservoir 110 on the rear portion 116 side of the fulcrum, its contents, and the other components of water feature 100 on that side of the fulcrum, such as an optional counterweight. The second position 103 of the reservoir 110 and the top portion 106 of the resin shell 105 may be at a second balance point, for example, a closed position of the resin shell 105.

While the reservoir 110 is rotating into the second position 103, the water inside the reservoir 110 may flow out of the open front end 118 of the reservoir 110 at a front portion 119 of the reservoir 110. When enough water flows out of the open front end 118 at the front portion 119 of the reservoir 110, the combined weight of reservoir 110 on the front portion 119 side of the fulcrum, its contents, and the other components of water feature 100 on that side of the fulcrum becomes less than the weight of reservoir 110 on the rear portion 116 side of the fulcrum, its contents, and the other components of water feature 100 on that side of the fulcrum. Water feature 100 then rotates about the pivot point 117 returning to the first position 102. This cycle repeats from open position 102 to closed position 103 while the water feature is in operation.

The water pump 125 may be rigidly mounted to the base 140 so that it is in a fixed location or may be unmounted from the base 140 and attached only by tube 125. The plurality of LED lights 150 may be coupled to locations on the resin shell 105 to illuminate, for example, when the water feature 100 is operating. The plurality of LED light 150 may be mounted at locations on the resin shell 105 to emulate eyes, for example, eyes on the character head. As shown in FIGS. 2-3, the plurality of LED lights 150 may be used for the eyes 151 of the character head 100. The ultrasonic fogger and air pump may be mounted at locations on or near the resin shell 105 to emulate smoke coming from the nostrils or air bubbles from breathing underwater for example. The LED lights 150, ultrasonic fogger/mister, air pump, sound module, and the water pump 125 may be powered by the plurality of solar panels 130. The plurality of solar panels 130 may be mounted at a top location of the resin shell 105, or may be mounted on a separate, complimentary object such as a floating water lily made of resin or other materials. The sound module may be configured to activate when the position of the reservoir 110 is either in the open position 102 or closed position 103. Additionally, an optional diverter (not shown) attached to a discharge hose (not shown) can also be connected to a nozzle (not shown) at the back of the base 140, which will propel the water feature to give the appearance of the water feature swimming.

While the present disclosure has been illustrated and described in detail in the drawings and foregoing description, the same is to be considered as illustrative and not restrictive in character, it being understood that only certain embodiments have been shown and described, and that all changes and modifications that come within the spirit of the present disclosure are desired to be protected.

What is claimed is:

1. A water device comprising:
a base;
a frame, said frame having a first end coupled to said base and an opposing second end, said frame extending away from said base;
a reservoir affixed to said second end of said base, said reservoir having a closed end and an opposing open end, said reservoir configured to pivot about a point of affixation to said second end of said frame;
a pump;
a tube fluidly coupling said pump to said closed end of said reservoir; and
a shell surrounding said base, said frame, and said reservoir, said shell comprising an upper component and a lower component, said upper component affixed to said reservoir and said lower component affixed to said base.

2. The device of claim 1, wherein said reservoir comprises a rigid tube capable of retaining a liquid.

3. The device of claim 1, further comprising one or more solar panels.

4. The device of claim 1, further comprising a plurality of illuminators.

5. The device of claim 1, further comprising an ultrasonic fogger, an ultrasonic mister, an air pump, and a sound module.

6. The device of claim 1, wherein said resin shell comprises a character head.

7. The device of claim 6, wherein said character head comprises an animal head.

8. The device of claim 1, wherein said pump is rigidly mounted to said base.

9. The device of claim 1, wherein said pump is unmounted from said base.

10. The device of claim 1, wherein said pump is operable to fill said reservoir with a liquid via said tube.

11. The device of claim 10, wherein when said reservoir is at least partially filled, said reservoir pivots about said point of affixation to said second end of said frame, causing said liquid to be released through said open end of said reservoir.

12. The device of claim 11, wherein when said liquid is released through said open end of said reservoir, said reservoir pivots about said point of affixation, returning to a position wherein said fluid can be retained in said reservoir.

13. A water apparatus, said apparatus comprises:
a rigid tube;
a pivot point, said rigid tube rotatable about said pivot point; and
a resin shell, said resin shell comprises a first position and a second position;
wherein said pivot point allows said rigid tube and a top portion of said resin shell to rotate between said first position and said second position;
wherein when said resin shell is in said first position when said rigid tube and said top portion of said resin shell are at a first balance point, which comprises said resin shell being in an open position; and
wherein when said resin shell is in said second position when said rigid tube and said top portion of said resin shell are at a second balance point, which comprises said resin shell being in a closed position.

14. The water apparatus of claim 13, wherein said rigid tube comprises a rigid PVC tube and is disposed within said top portion of said resin shell.

15. The water apparatus of claim 14, wherein said rigid tube comprises a closed rear end, an open front end, a rear portion and a front portion.
